(19) United States
(12) Patent Application Publication
(10) Pub. No.: US 2021/0072882 A1
(43) Pub. Date: Mar. 11, 2021

(54) User Interface for Designing Photo-Book Layouts

(71) Applicants: Andrew M. FUNDERBURG, Beaverton, OR (US); Jonathan D. STICKLES, Beaverton, OR (US)

(72) Inventors: Andrew M. FUNDERBURG, Beaverton, OR (US); Jonathan D. STICKLES, Beaverton, OR (US)

(73) Assignee: Fundy Software, Inc., Beaverton, OR (US)

(21) Appl. No.: 16/562,235

(22) Filed: Sep. 5, 2019

(51) Int. Cl. G06F 3/0484; G06T 11/60; G06F 3/01

(52) U.S. Cl. CPC G06F 3/04845; G06T 2200/24; G06F 3/016; G06T 11/60

(57) ABSTRACT

A computer user interface improves speed and accuracy of manual operations in an image layout process where an array of rectangular images are placed adjacent each other so as to cover a rectangular area without gaps or overlap. The interface provides support for two different adjustments: a border between a pair of adjacent images covering a “duocell” rectangle may be adjusted from side to side, altering the aspect ratio of the area available to display each of the images; or a row border between two adjacent rows of images covering a “duorow” rectangle may be adjusted, altering the aspect ratio of every image having an edge adjacent to the row border. The user interface accepts user input to adjust the relevant border, recomputes the images to be displayed under the new aspect ratios, and presents the display in a “what you see is what you get” (“WYSIWYG”) manner. Several extensions communicate important information to the user while such adjustments are being made.

### CONTINUITY AND CLAIM OF PRIORITY

This is an original U.S. patent application.

### FIELD

The invention relates to prepress design and layout. More specifically, the invention relates to novel computer user-interface interaction methods and operator controls to streamline the process of laying out a series of heterogeneous rectangular images into a rectangular space for printing, thus increasing the accuracy and efficiency of an operator performing this work on a computer system.

### BACKGROUND

In the past, photo albums and picture books were the product of a labor-intensive series of manual manipulations of physical objects: a photographer would capture images onto film; the film would be developed to produce negatives; the negatives would be printed onto paper; and the paper photos would be arranged onto a page for delivery or for further operations leading to printing (e.g., offset printing) of multiple copies of the page. The process would often include cropping or resizing of photos to obtain an attractive, balanced composition, and for low-volume production, layout often involved cropping or resizing to match pre-cut windows in a mat board (rather than cutting custom mats to suit an arbitrary layout of ideally-cropped and -sized images on the page). Thus, in addition to the intricate manual process, the result was often constrained by the number and configuration of pre-cut mats: a designer laying out three images on a page might have only two or three different options for photo position, size and aspect ratio. (The alternative of cutting arbitrary custom mats for each page is prohibitively expensive for many projects.)

With the development of digital photography and high-bandwidth data connections among devices (such as via the Internet), photos are now more commonly shared one at a time or in an array or slide show on a transient display device such as a multi-pixel screen (e.g., an LCD monitor, a laptop screen, a tablet device or an electronic picture frame), and/or via other impermanent distribution mechanisms such as website galleries. However, consumers still desire permanent physical copies of some photo sets, such as wedding albums, graduation pictures and childhood memories books. And although many of the photos in such physical albums are often created through a digital process, the facilities for laying out the photos into printable spreads still emulate the traditional “template” model, where the designer must select from among a small number of arrangements and photo sizes matching the number of photos to be displayed on the page. (Or alternatively, the creator of the photo layout software must produce an enormous number of templates with different layouts, sizes and aspect ratios for each number of photos on a page, and the designer must be familiar with the many templates to achieve the desired effect.) Either way, simply replicating traditional paper-based photo layout procedures into software does not take advantage of the flexibility and power that computer-based layout could offer, and does not yield the labor (and cost) savings that might be expected.

Developments in this field, for example as described in U.S. Pat. No. 9,116,648 by the present inventors, brought substantially improved flexibility to electronic (computer) layout of photo albums. However, the computer user-interface mechanisms that an operator used to control the layout tasks were largely modeled after the familiar manual tasks that earlier technicians used to perform physical layout. These interfaces had the advantage of requiring little training, but suffered from some of the limitations of physical layout, and sometimes permitted the sorts of errors that could occur in a physical layout.

Now that layout technicians have become more familiar with computer-mediated layout creation, improved user-interface techniques and controls can streamline their work, allowing them to complete it faster and with fewer errors. These efficiency improvements may be of value in this field.

### SUMMARY

A computer-implemented user-interface method improves accuracy and efficiency of manual layout of rectangular images to cover a rectangular area such as a display window or a printed page. Images are arranged in uniform-height rows, where at least one row comprises a plurality of images placed side-by-side. The user interface facilitates two different modifications: either adjusting a cell boundary between two adjacent images to change the aspect ratios of the portions of the rectangular area allocated to the adjacent images; or adjusting a row boundary between two adjacent rows to change the aspect ratios of all of the image-display areas sharing an edge with the row boundary. After the image-display areas' aspect ratios are adjusted, the user-interface method recomputes and redisplays the affected images. The layout can be defined hierarchically, with a number of images being tiled within a rectangular area in a parent layout. Visual, audible and haptic information feedback features communicate status information to the user to help avoid layouts that will experience reproduction-quality issues.

### BRIEF DESCRIPTION OF DRAWINGS

FIG. 1 shows a first layout editing operation according to an embodiment of the invention.

FIG. 2 shows a second layout editing operation according to an embodiment of the invention.

FIG. 3 shows the simplest layout where an embodiment can operate.

FIG. 4 shows a more-complex layout where an embodiment can operate.

FIG. 5 shows a user-feedback/computer-assisted editing feature that may be implemented by an embodiment of the invention.

FIG. 6 shows a layout that is not supported by an embodiment, and a visually-indistinguishable alternate layout that is supported.

FIG. 7 outlines a method of reconfiguring images to fit in available display locations according to an embodiment.

FIG. 8 shows example image changes that may occur as an aspect ratio of a display area changes.

FIG. 9 shows how an image may be composited into a rectangular layout as editing is carried out.

FIG. 10 shows two different alternatives for automatic image aspect-ratio modification corresponding to a user's row-border change.

FIG. 11 introduces the concepts of “duocells” and “duorows.”

FIG. 12 illustrates layout changes that may occur when one portion of a duocell contains a child hierarchical layout.

FIG. 13 illustrates layout changes that may occur when a duorow being edited affects an image position that contains a child hierarchical layout.

FIG. 14 shows a practical layout with actual images instead of placeholders.

### DETAILED DESCRIPTION

Embodiments of the invention implement a computer user interface for controlling an image layout process. The layout process places, sizes and crops a plurality of images to fit within (and tile to fully cover) a rectangular region. The rectangle is divided along one axis into two or more rows, each row spanning the entire rectangle; and at least one of the rows is divided along a perpendicular axis into two or more rectangular cells, where each cell holds an image. (An undivided row comprises a single image cell.) Additional user-interface features surround and support the central layout paradigm. An embodiment offers drag-and-drop design control. Automatic image resizing and full-layout resizing are available. Other features, described below, are closely coupled to the row-and-column structure of an embodiment.

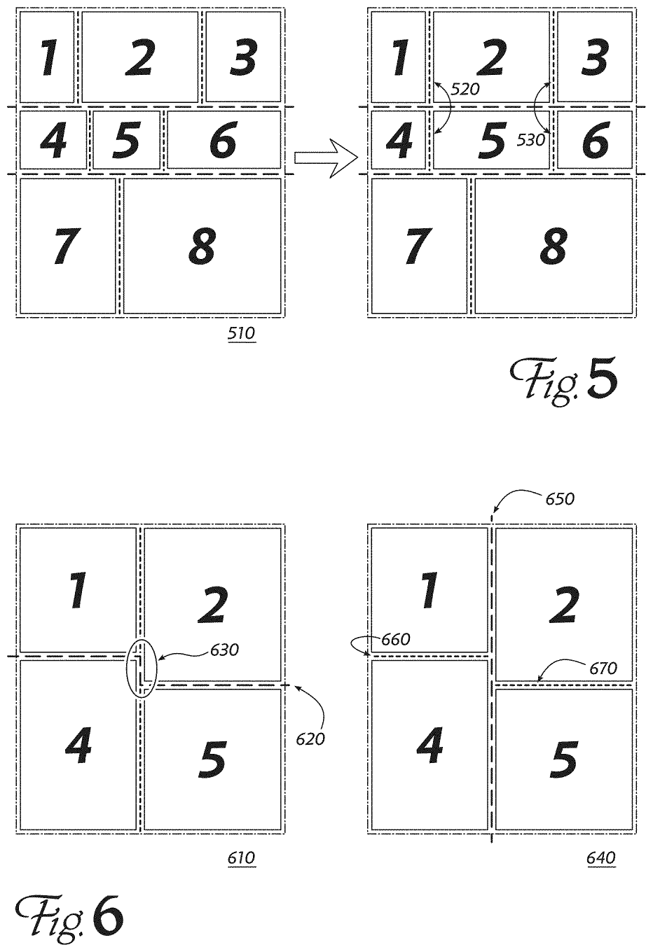

FIG. 3 shows the simplest layout where an embodiment can operate: a rectangular area 300 is divided along boundary 310 into rows 320 and 330; and row 330 is divided by an orthogonal boundary 340 into two cells (350, 360). The rectangles labeled with bold numerals represent rectangular images displayed within the cells.

The rectangular area is sometimes divided into more than two rows, and some of the rows may be divided into more than two cells. FIG. 4 shows an example: the rectangular area 400 is divided into three rows (410, 420, 430) by horizontal boundaries 412 and 423. Row 430 has two cells (440, 450) divided by boundary 445; and row 410 is divided into three cells (460, 470, 480) by boundaries 467 and 478.

Since rows can have different numbers of cells, the rectangular region does not necessarily have “columns” of similar width cells, but an embodiment can provide feedback to assist the user in setting cell widths to be equal, as shown in FIG. 5. At 510, none of the cells have the same width (although cells 1, 2 and 3 are the same height; 4, 5 and 6 are the same height, and 7 and 8 are the same height). However, the border between cells 4 and 5 can be moved to the left, and when it is nearly below the border between 1 and 2, the user interface may “snap” it to be exactly below, as shown at 520. Similarly, the border between 5 and 6 may be adjusted to be near the border between 2 and 3, and when it is near, the user interface may perform a similar “snap” adjustment (530).

FIG. 6 shows an illegal layout at 610: the interface does not support a row-dividing border 620 having a departure from a straight line (circled at 630). However, a visually-indistinguishable layout can be constructed as shown at 640, by exchanging the horizontal (“row”) division with the vertical (“column”) divisions. By plotting the top-to-bottom divider 650 vertically, two uniform-width columns are established, and cell dividers 660, 670 create two image cells in each column.

Note that each image cell in a layout according to an embodiment of the invention is a rectangle, and can therefore be further subdivided hierarchically, using a new set of rows (or columns) and corresponding orthogonal cell boundaries to split up the space available for image display. The “major” direction of each hierarchical level is independent from higher and lower levels, so it is possible to split up cells in a row in level 1, into columns of cells in level 2. Software implementing an embodiment may function recursively to calculate the space available for an image at each level of a hierarchy.

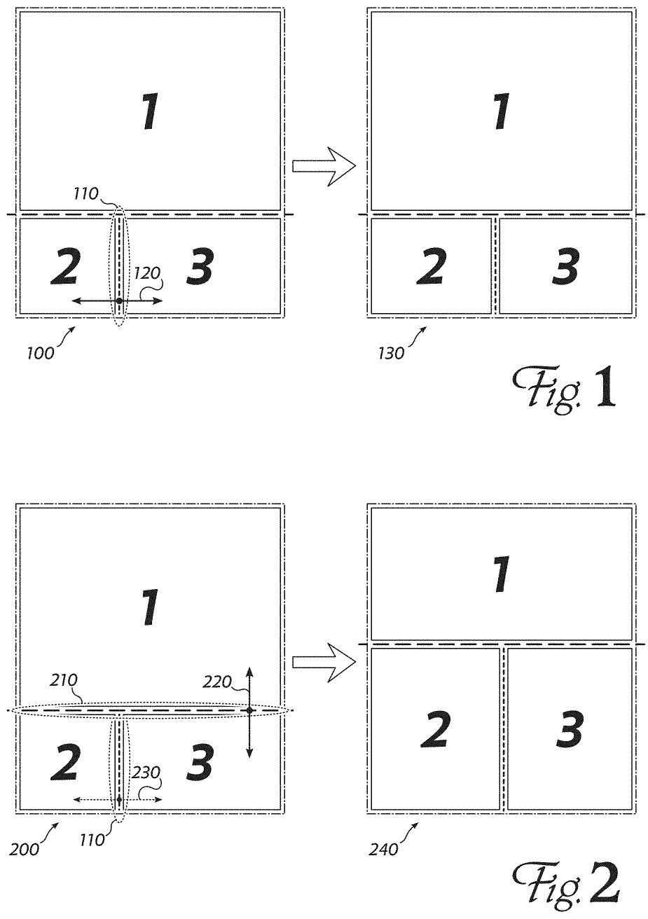

FIG. 1 shows a first user-interface operation according to an embodiment of the invention. The two-row, three-cell layout 100 (i.e., the simplest layout from FIG. 3) is altered by the operator, who selects inter-cell border 110 and adjusts its position left or right 120. As the position of border 110 is adjusted, the user interface alters and re-displays images 2 and 3 as explained below. When the user is satisfied with the altered layout, the inter-cell border is released and layout 130 is confirmed. As is common with WYSIWYG (“what you see is what you get”) user interfaces, an “Undo” function may be provided to return the altered image 130 to its pre-alteration arrangement 100.

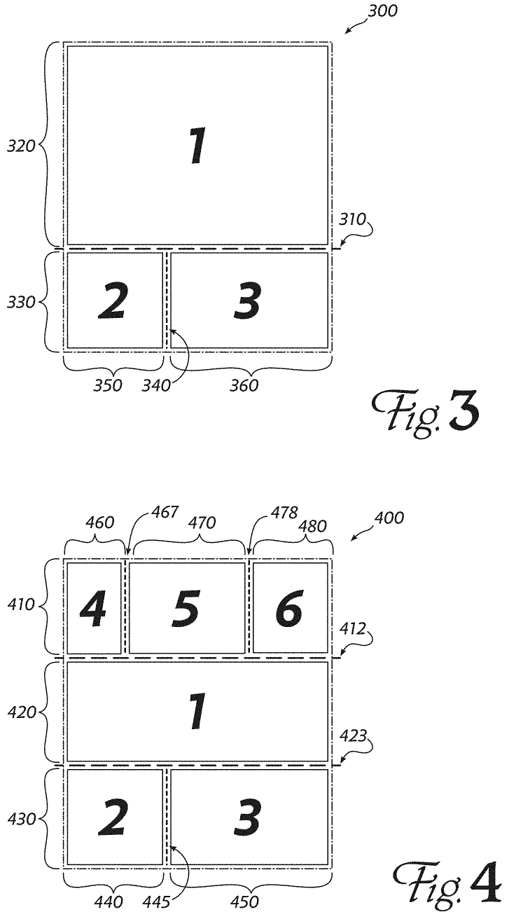

FIG. 2 shows a second user-interface operation according to an embodiment of the invention. Starting with the same two-row, three-cell layout 200, the user may select inter-row border 210 and adjust its position up or down 220. While the user does this, the system may also adjust inter-cell borders of images adjacent to the active border 210, as indicated at 230. The conditions and behavior of such adjustments are discussed below. When the user is satisfied with the altered layout, the inter-row border is released and layout 240 is confirmed.

More generally, the two user-interface operations adjust a border between two adjacent cells, or a border between two adjacent rows. When the user adjusts a cell border, only the two images adjacent the border are affected. When the user adjusts a row border, all of the images having an edge adjacent the row border are affected.

Before describing the heuristics governing the computer-implemented operations of an embodiment, it is helpful to set forth a number of guiding principles and specific definitions for words and phrases that will be used in the description. First, embodiments are useful when laying out arrangements of rectangular raster images. These are digital images comprising an m x n array of single-color picture elements or pixels. Layouts (and the images comprising them) are usually intended for display or output on a device such as a raster display or a laser printer. These output devices have a predetermined output resolution, often expressed as “dots per inch” (dpi) or “pixels per inch” (ppi). For best reproduction results, it is preferable that raster-image pixels map one-to-one to output image elements. When 1:1 mapping is not possible, whole-number:1 mappings are usually acceptable. Real-number:1 mappings (where the real number is greater than one) are next preferred, followed by fraction:1 mappings (where the fraction is between zero and one). The last mapping occurs when a raster image is enlarged to cover more output pixels than there are image pixels. Enlargement often causes reduced output image quality.

Second, all of the rectangles involved in operations according to an embodiment have a dimensionless characteristic, the aspect ratio. This is the ratio between the width and length of the rectangle's sides. Width and length may be expressed in terms of pixels, millimeters, inches, or another metric. They may be whole number or real number quantities. Since an aspect ratio is the quotient of two such quantities, the “units” portions cancel, leaving a dimensionless real-number quantity. Aspect ratios are commonly expressed as width:height (e.g., 640:480, 4:3 or 1.33:1 all represent identically-proportioned wider-than-tall rectangles). When an aspect ratio is expressed so that the height is 1 (one), then only the corresponding width may be stated. Under this nomenclature, aspect ratios less than 1.0 correspond to tall, skinny rectangles; while aspect ratios greater than 1.0 correspond to short, wide rectangles. Embodiments adjust raster images (each of which has a particular natural aspect ratio) to fit within layout rectangles or image cells which may have different aspect ratios. The adjusting occurs deterministically and reversibly, so it can be comprehended and manipulated efficiently by an operator using a WYSIWYG user interface implementing an embodiment to perform layout tasks.

Finally, when a rectangular image having a first aspect ratio is displayed within a rectangle having a second, different aspect ratio, some portions of the image must be hidden or cropped. (A similar cropping occurs if the image and the display rectangle have the same aspect ratio, but the user has enlarged or zoomed the image so that only a portion of the image appears within the display rectangle.) The amount of image cropped beyond the borders of the display rectangle may be described by the number of raster rows or columns outside the display image, or (equivalently) by the association of a (row, column) pixel coordinate of the image with a corresponding (x, y) coordinate of the display rectangle.

When a cell border of a layout is adjusted, the space available to display the images in the adjacent cells becomes larger or smaller in at least one direction (taller or shorter; or wider or narrower). When a row border is adjusted, it is also possible that the space an image occupies becomes larger or smaller in an orthogonal direction. For cell-border adjustments, the aspect ratio of the affected image spaces always changes. For row-border adjustments, the aspect ratio of many of the affected image spaces often changes. Embodiments operate to cause the images displayed in these changing-aspect-ratio spaces, to change in a reliable and predictable way, so that the user can achieve the desired layout appearance with fewer modifications and less editing time.

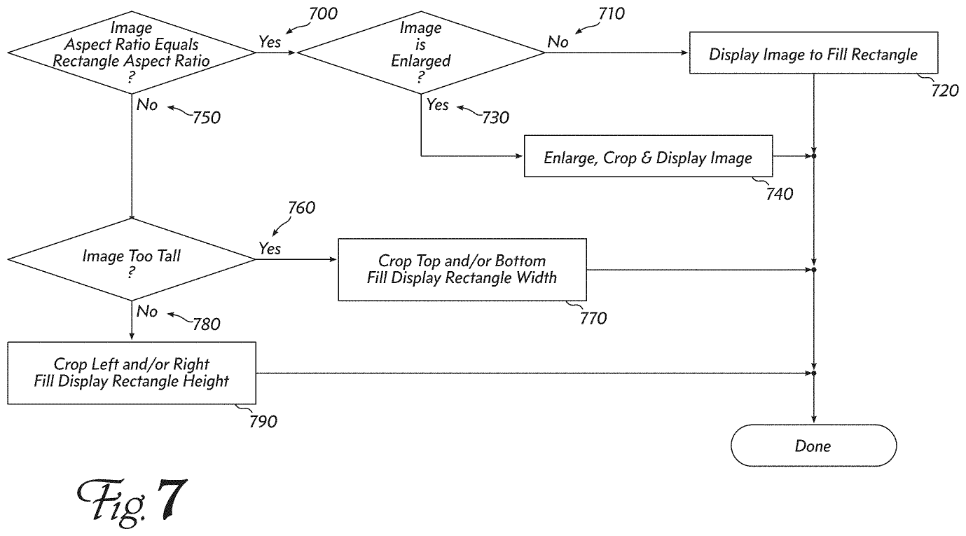

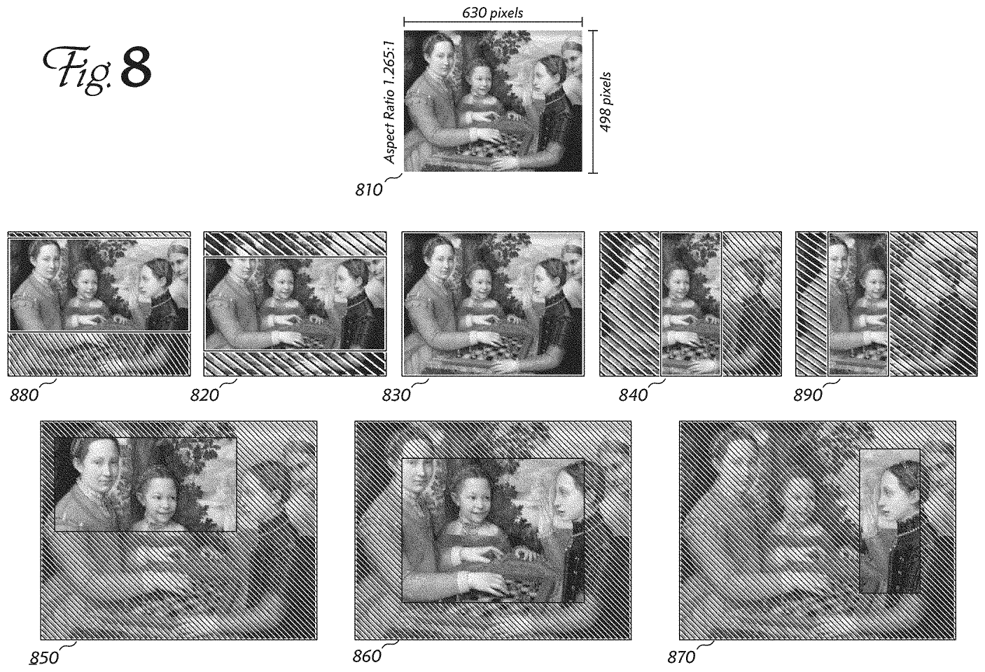

The process by which an embodiment determines the portion of a raster image to display within a particular rectangle is outlined in FIG. 7. If the image aspect ratio is equal to the display rectangle aspect ratio (700), then if the image has not been enlarged or zoomed (710), then the image simply fills the display rectangle (720). If the image has been enlarged (730), then suitable portions are cropped from top, bottom, left and/or right for display (740).

If the image aspect ratio is different from the display rectangle aspect ratio (750), then if the image aspect ratio is greater than the display rectangle aspect ratio (i.e., the image is “too tall,”) (760), the top and/or bottom of the image are cropped, and the image is displayed to fill the display rectangle width (770). This cropping hides a portion of the image, making the remaining portion appear more prominent, so it appears to have “zoomed in” even though no enlargement may have taken place.

If the image aspect ratio is less than the display rectangle aspect ratio (i.e., the image is “too wide,”) (780), then the left and/or right of the image are cropped, and the image is displayed to fill the display rectangle height (790). Again, cropping appears to zoom in even though no enlargement may have taken place.

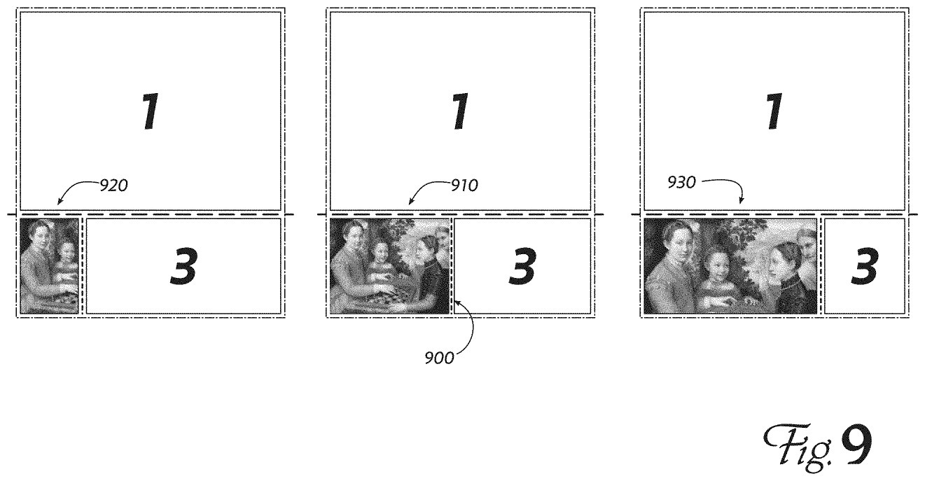

FIG. 8 shows a sample image 810 (630×498 pixels, 1.265:1 aspect ratio) displayed in too-wide 820, just-right 830 and too-tall 840 display rectangles when the image has not been enlarged, and the same image displayed in similar-aspect-ratio display rectangles when the image has been enlarged (850, 860, 870). When a portion of an image is cropped (most examples), the cropping need not be uniform top-to-bottom (880) or left-to-right (890).

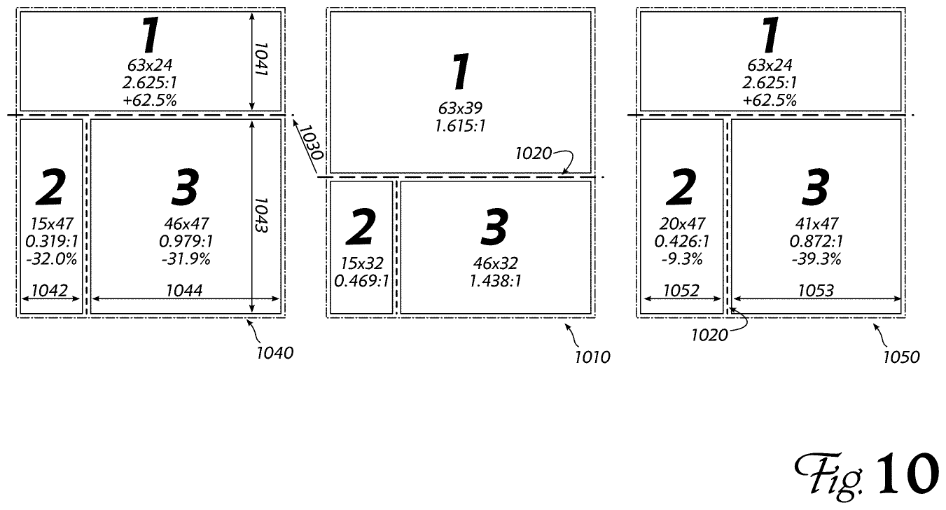

FIG. 8 shows “windows” over a portion of an image, where the window changes aspect ratio and size. But the inventive user interface actually manipulates borders of image display cells, whose fixed and modifiable dimensions change under the user's control, while the portion of the image displayed is automatically computed and updated. Thus, the display that a user sees and interacts with is somewhat different from what is shown in FIG. 8. FIG. 9 shows the display that a user sees while operating an embodiment.

In the center display, image 910 is shown in the lower-left image display cell, whose aspect ratio matches the image. Thus, the whole image is displayed. If the cell border 900 is adjusted to the left, the aspect ratio of the lower-left cell increases, and only a portion of the image is displayed (920). The cropped portion of the image is not apparent to the user.

If the cell border is adjusted to the right, the aspect ratio of the lower-left cell decreases, and the image must be enlarged so that its width fills the cell. The enlargement causes the top and/or bottom of the enlarged image to be cropped, leaving portion 930. Note that the portion of the full image that is displayed in any image cell having a different aspect ratio, may be adjusted by “sliding” (i.e., panning) the image horizontally and/or vertically to bring the portion of interest into view. When subsequent layout adjustments affect the aspect ratio of the cell, the system automatically zooms and/or scans to keep the portion of interest in view to the extent possible.

An important characteristic of a user interface implementing an embodiment is reversibility of display changes. When a cell or row border is moved, all of the adjacent images change by panning and/or scaling to fit the new image-cell aspect ratios. If the user moves the border back to its starting position, then the images should return to their starting configuration as well.

As mentioned earlier, when a cell border is adjusted, the two images adjacent the border change, so both of them are recomputed and redisplayed as described above. When a row border is adjusted, all of the images having an edge adjacent the border are adjusted, recomputed and redisplayed. There will be at least two such images (if the border is between two undivided rows), but there may be many images that will all be adjusted. And when an image cell is subdivided hierarchically into a child set of images managed by a recursively-defined set of row and column borders, then changing the aspect ratio of that image cell changes the space available to all of the images in the child set. Thus, changing any border often results in a large number of images being redisplayed.

In one embodiment of the invention, changing a row border does not affect any orthogonal cell border (other than to make the cell borders longer or shorter). In another embodiment, changing a row border can alter orthogonal cell borders in a way that improves the overall layout appearance. The difference between these embodiments is illustrated in FIG. 10. At 1010, a two-row, three-image starting layout is shown. The user moves row-border 1020 up (1030). If the orthogonal cell boundaries are not altered, then the result is shown at 1040. The heights of the rows (1041, 1043) are different, but the widths of image cells 2 and 3 are unaffected.

In another embodiment, multiple cells in a row adjacent the adjusted row border are adjusted to preserve their relative areas. This is shown in layout 1050. The area of the row containing images 2 and 3 increases because row border 1020 is raised. As 1020 is moved up, this increased area is allocated to 2 and 3 in the same ratio as the areas of 2 and 3 in the original layout 1010. Thus, image cell 2 increases in width 1052 while image cell 3 decreases in width 1053 (cell border 1060 moves to the right). Of course, if image cells 2 and 3 were equally-sized in the starting layout, these two embodiments would produce identical results.

In either embodiment, once the image cells are resized, the image contained in each is reconfigured (re-cropped, resized) and displayed. Again, it is important that the adjustments be reversible, so that if the user returns the border under adjustment to its original position, the images also return to their original configurations.

FIG. 11 shows a more-complex layout. The inventive user interface allows the user to adjust two different types of borders. The first is a cell border, which separates exactly two rectangular areas containing images (one or both areas may instead contain a hierarchical subdivision into other rows and columns of images). The second is a row border, which separates exactly two rectangular areas, each of which may be subdivided into two or more cells.

In either case, adjusting such a border affects two adjacent rectangular areas, but does not affect anything outside the two rectangular areas. Thus, an embodiment need not recompute or redisplay anything outside those areas. In FIG. 11, heavy borders indicate the two different rectangular areas described. Border 1110, surrounding images 2 and 3, defines a “duocell”: a rectangular area surrounding the two images adjacent to cell border 1120. When cell border 1120 is moved left or right, the aspect ratios of the rectangles where 2 and 3 are displayed change, but the height of both images stays the same (as does the height of the entire row, which also includes image 1—unaffected by adjustment of cell border 1120). Any two adjacent images in a row can be treated as a duocell when the border between them is adjusted. An embodiment need not recompute or redisplay images outside the duocell.

Similarly, border 1130 defines a “duorow”: a rectangular area surrounding all of the images of two adjacent rows. The rows are separated by a row border 1140. When a row border such as 1140 is adjusted, all of the images having an edge adjacent the border are affected. The “south” edges of images 4, 5 and 6; and the “north” edges of images 7 and 8 are adjacent row border 1140. Adjusting 1140 changes the aspect ratio of all of the rectangles where images 4 through 8 are displayed, so all of those images must be reconfigured and redisplayed as the user moves row border 1140. However, the row containing images 1, 2 and 3 lies outside duorow 1130, so none of those images need be altered.

It is appreciated that if one of the image display rectangles is subdivided into a hierarchical “child” rectangular array, all of those images must be reconfigured when the “parent” display rectangle's aspect ratio changes. As discussed earlier, when border 1140 is moved, the cell borders may remain equidistant from each other and simply become longer or shorter; or in another embodiment, the position of the cell borders may automatically be adjusted perpendicularly to the motion of border 1140 to preserve the relative areas of the image display rectangles.

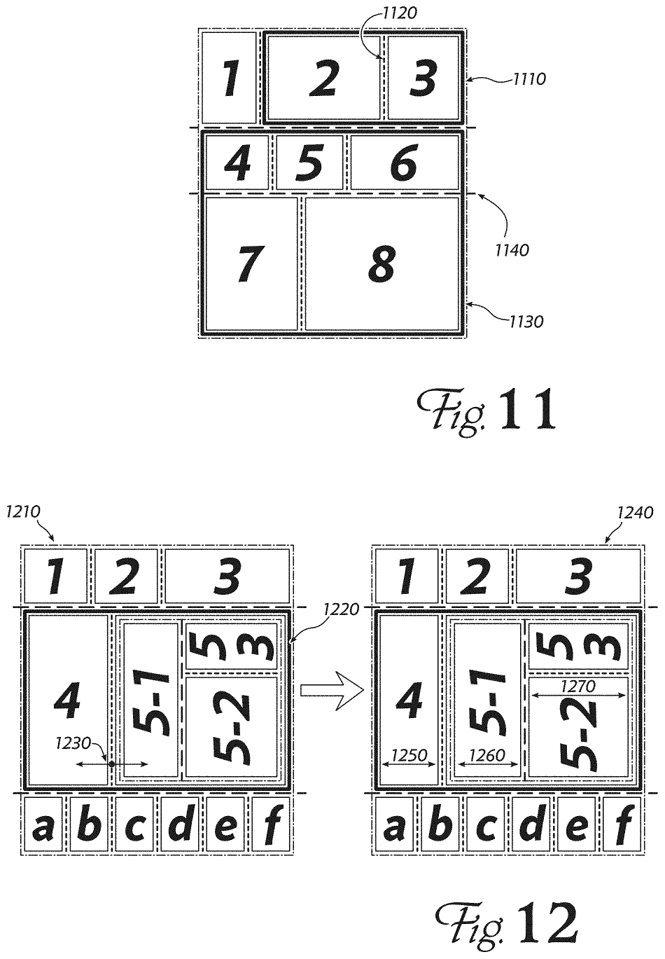

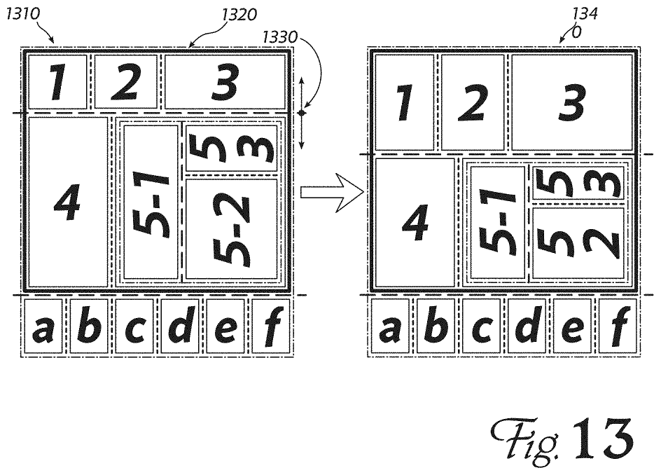

FIG. 12 shows a sample reconfiguration of a layout 1210 which includes a child layout within duocell 1220. (The image identifiers 5-1, 5-2 and 5/3 are rotated 90° to indicate that the child-layout “rows” are oriented perpendicularly to the “rows” of parent layout 1201.) When the cell border is adjusted, 1230, the layout may be altered as shown at 1240. There, the width of image cell 4 (1250) has been reduced, and the width of the child layout (which is the sum of the child row heights 1260 and 1270) has been increased.

Similar parent-to-child layout propagation also occurs when one of the image cells in a duorow is affected by a row-border adjustment. This is shown in FIG. 13. Layout 1310 is the same as 1210 from FIG. 12, but here, duorow 1320 is being modified by adjusting the row boundary (1330). At 1340, the “after” layout is depicted. In this example, the cell borders orthogonal to the row border being adjusted are not moved. However, in an alternate embodiment, image cells affected by the row adjustment may have their relative areas preserved by automatic cell-boundary adjustment that is proportional to the row adjustment.

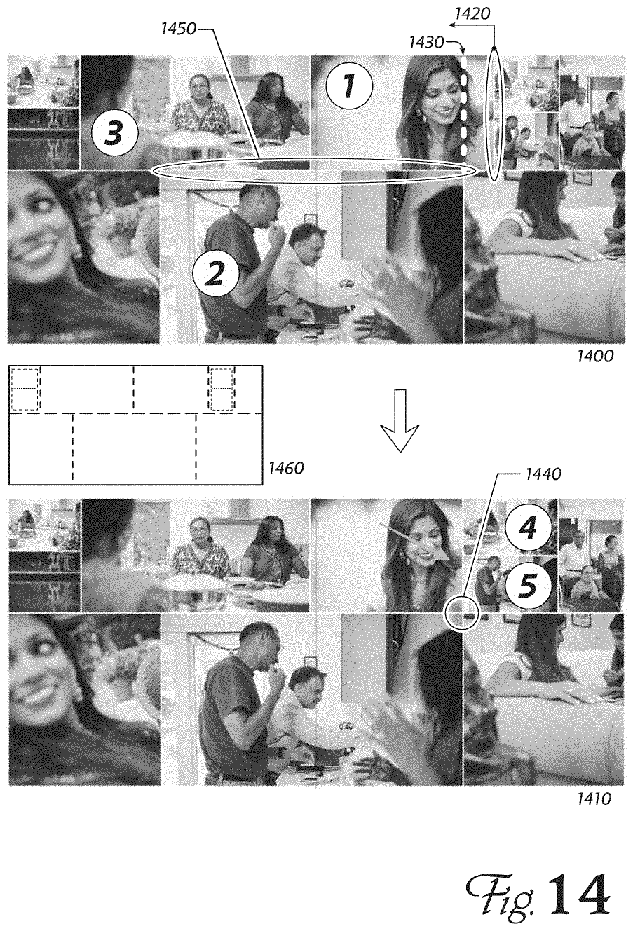

FIG. 14 shows screenshots from a practical layout. An operator using an embodiment can change the layout of 1400 to the layout of 1410 by moving border 1420 to the left, stopping at location 1430. A “snap” or “magnetic” feature of the embodiment may assist in aligning border 1420 with the vertical border in the neighboring row, thus aligning adjacent corners of four images as indicated at 1440. Note that the embodiment has panned image 1 to the left in response to the changing aspect ratio of the duocell of images 1 and {4, 5} during this modification; it did not simply crop additional pixels off the right side of the image.

As described above, it is appreciated that the north border of image 2, indicated at 1450, cannot be adjusted up or down by itself, because the border does not extend fully across the south edges of images 1 or 3. Thus, to adjust the relative heights of the top-level duorow, the entire horizontal border must be moved up or down. By contrast, border 1420 can be adjusted left or right, because the border extends fully across the west sides of both images 4 and 5. Those images are part of a child hierarchical duorow, as illustrated in the possible layout structure shown at 1460. It should be recalled that embodiments can make visually-indistinguishable layouts that have different hierarchical structures. The different structures may support the independent adjustment of different borders within the layout (i.e., a duocell border, or a duorow border).

In addition to the continuously-updated image display performed by an embodiment while the user is adjusting a row or cell border, the embodiment may emit additional indicators to communicate important status information to the user. Since a large proportion of the activities of an embodiment are visual in nature, visually-perceptible indicators may be preferred. For example, various conditions may be displayed via color changes in the borders of images. However, audible or haptic (tactile) feedback may also be used to spread the information desired to be communicated across the user's senses. This may help prevent overloading the user with hard-to-decipher visual information.

An embodiment may indicate when an image's aspect ratio precisely matches the aspect ratio of the cell in which it is displayed. It may also indicate when an image's resolution is an integral multiple of a final output resolution—as noted earlier, integer input:output ratios may provide improved reproduction. For example, an image's border may flash green when aspect ratios are an exact match. Embodiments may also “shave” images by removing a few border rows or columns of pixels to make the remaining image fit the available space with an integral reproduction ratio. Shaving may also provide improved reproduction compared to a strictly mathematical scaling where each output pixel corresponds to 1+ε (0<ε<<1) image pixels. An image may be displayed with a yellow border when it is near a preferred aspect ratio and/or scaling factor, and where the discrepancy can be corrected by shaving the image. A suitable value for E may be from 1/(number of pixels) to about 8/(number of pixels).

An embodiment may also provide feedback during editing by “snapping” a border to a favorable position. For example, a cell border in one row may snap to a nearby cell border in a different row. A similar snap feedback may indicate preferred image-resolution characteristics.

With the duorow/duocell layout engine described above at the core of a photo layout editing program, conventional user-interface features can be added to improve overall workflow efficiency. For example, a standard “drag and drop” action can add a new image between a pair of existing images in a duocell (images can also be dragged from one place in a layout to another place). The same logic that responds to changing image-cell aspect ratios can accommodate a prior-art rectangular “rubberband” resizing of the top-level layout rectangle (i.e., the full-page layout).

Other user-interface features are only relevant to duorow/duocell layouts. For example, a vertical stack of horizontal duorows may be automatically reconfigured as a plurality of side-by-side vertical duocolumns. Hierarchical child layouts that are edited to contain only one row or one column of images may be automatically promoted to the parent level. A structure optimizer may be provided to simplify a deep hierarchical tree of sub-duorows and sub-duocolumns into a visually-indistinguishable, shallower hierarchy that behaves more simply and transparently as cell and row borders are adjusted.

An embodiment of the invention may be a machine-readable medium, including without limitation a non-transient machine-readable medium, having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

The instructions implement user-interaction logic that operates at a nexus between a computer comprising user input hardware such as a mouse, trackball, pen input, or touchscreen; user output hardware such as a raster display; operating system software that manages low-level interaction with the user input and output hardware; photo-layout editing software that is controlled by signals from the user input hardware and that generates visible feedback for display on the output hardware; and the user. Terms for various user-interface actions have entered the vernacular; unless otherwise specified, these terms have their customary meanings. Thus, for example, “the user grabs the cell border” means “the user manipulates an input device such as a mouse to move an on-screen pointer near the cell border, then alerts the software to begin a modification of the cell border by pressing a button.” Similarly, “drag” means “move an object displayed on screen to a different position, such movement corresponding to the user's manipulation of an input device.”

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a non-transient machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that computer user interfaces for operating photo layout processes can also be implemented by software and hardware that distribute the functions of embodiments of this invention differently than herein described. Such variations and implementations are understood to be captured according to the following claims.

1. A method for improving efficiency and accuracy of photo-book layout by an operator using photo layout software, comprising:
displaying a two-dimensional array of rectangular images having a first row of a first height, said first row containing a first image whose height matches the first height, and
a second row of a second height, said second row containing a second image whose height matches the second height and a third image whose height matches the second height,
the first row and the second row immediately adjacent a row border, and
the second image and the third image immediately adjacent a cell border;
reconfiguring the second image and the third image but not the first image while a user adjusts the cell border;
reconfiguring the first image, the second image and the third image while the user adjusts the row border; and
redisplaying the two-dimensional array of rectangular images after any of the first, second or third images is reconfigured.

2. The method of claim 1 wherein reconfiguring an image comprises:
computing an image aspect ratio of an image;
computing a display aspect ratio of an image cell where the image is to be displayed;
if the display aspect ratio equals the image aspect ratio, displaying the image in the image cell without enlargement or cropping;
if the display aspect ratio is wider than the image aspect ratio, cropping a portion of a top or a bottom of the image before displaying the image across a full width of the image cell; and
if the display aspect ratio is taller than the image aspect ratio, cropping a portion of a left side or a right side of the image before displaying the image across a full height of the image cell.

3. A what-you-see-is-what-you-get (“WYSIWYG”) interactive image layout editing method, comprising:
computing a rectangular display fully tiled by at least three (3) rectangular images, said rectangular display having at least two image rows extending fully from side to side of the rectangular display, where each image row consists of at least one image cell, and at least one image row consists of a plurality of image cells, each image cell containing a rectangular image;
displaying the rectangular display on a transient output device;
receiving user input to adjust a position of a cell border in a direction orthogonal to the cell border, said adjustment to change an aspect ratio of every image cell having an edge adjacent to the cell border resulting in post-change aspect ratios;
receiving user input to adjust a position of a row border in a direction orthogonal to the row border where at least one image row adjacent the row border consists of a plurality of image cells, said adjustment to change an aspect ratio of every image cell having an edge adjacent to the row border resulting in post-change aspect ratios; and
repeating the computing and displaying operations using the post-change aspect ratios.

4. The WYSIWYG interactive image layout editing method of claim 3 wherein
the rectangular display includes a hierarchical rectangular image cell,
said hierarchical rectangular image cell is subdivided into at least two hierarchical image rows extending fully from side to side of the hierarchical rectangular image cell, and
one hierarchical image row consists of a plurality of hierarchical image cells, each hierarchical image cell containing a rectangular image.

5. A tangible computer-readable medium containing instructions and data to cause a computer having a display and a pointing device to interact with a user of the computer by performing actions comprising:
displaying a rectangular area fully tiled with rectangular images, said rectangular area having a first row containing a first image adjacent a second row containing second and third images, said second and third images occupying adjacent portions of a rectangular image duocell with a cell border between the images, and said second and third images each having an edge adjacent a portion of an edge of the first image in the first row;
beginning a live cell-border feedback loop when a user adjusts the cell border between the second and third images;
reconfiguring the second and third images to fit the rectangular image duocell without adjusting outer boundaries of the duocell; and
repeating the displaying operation with the reconfigured second and third images; until the user ceases adjusting the cell border; and
beginning a live row-border feedback loop when the user adjusts a row border between the first row and the second row;
reconfiguring all images having an edge adjacent the row border without adjusting outer boundaries of a duorow tiled by the first row and the second row;
repeating the displaying operation with the reconfigured all images until the user ceases adjusting the row border.

6. The tangible computer-readable medium of claim 5 containing additional instructions and data to cause the computer to perform actions comprising:
displaying a color border around an image when an aspect ratio of the image matches an aspect ratio of an image cell within which the image is displayed.

7. The tangible computer-readable medium of claim 5 containing additional instructions and data to cause the computer to perform actions comprising:
emitting a tactile (hap tic) signal to the user when a scaling ratio of an image is greater than 1.0 but less than 1.0+8/(number of pixels).

8. The tangible computer-readable medium of claim 5 containing additional instructions and data to cause the computer to perform actions comprising:
snapping a border being adjusted during a live cell-border feedback loop or a live row-border feedback loop to a position adjacent a different border when the border being adjusted is near the different border.

9. The method of claim 1 wherein reconfiguring the first image, the second image and the third image while the user adjusts the row border comprises:
altering the height of the second image and the third image without altering a width of the second image or a width of the third image.

10. The method of claim 1 wherein reconfiguring the first image, the second image and the third image while the user adjusts the row border comprises:
altering a second width of the second image and a third width of the third image to preserve a ratio between a second area of the second image and a third area of the third image.
